(19) United States
(12) Patent Application Publication
(10) Pub. No.: US 2020/0189619 A1
(43) Pub. Date: Jun. 18, 2020

(54) VEHICLE AND CONTROL DEVICE AND CONTROL METHOD OF THE VEHICLE

(71) Applicant: HONDA MOTOR CO., LTD., Tokyo (JP)

(72) Inventor: Shigehiro HONDA, Wako-shi (JP)

(21) Appl. No.: 16/803,091

(22) Filed: Feb. 27, 2020

Related U.S. Application Data
(63) Continuation of application No. PCT/JP2017/032296, filed on Sep. 7, 2017.

(51) Int. Cl. B60W 60/00; B60W 40/068; B60W 10/20; B60W 50/14; B60W 30/18

(52) U.S. Cl. CPC B60W 60/0053; B60W 40/068; B60W 2552/40; B60W 50/14; B60W 30/18054; B60W 10/20

(57) ABSTRACT

A control device that performs travel control of a vehicle includes a sensor that detects a state of the vehicle and a situation around the vehicle, a travel control unit that performs travel control for automated driving based on detection results of the sensor, and a road surface determination unit that determines whether a road surface on which the vehicle is traveling satisfies a predetermined condition. During execution of stop transition control of decelerating or stopping the vehicle, the travel control unit moves the vehicle to an off-road area adjacent to a traveling road when the road surface determination unit determines that the road surface on which the vehicle is traveling satisfies the predetermined condition, and otherwise causes the vehicle to stay on the traveling road.

### CROSS-REFERENCE TO RELATED APPLICATION(S)

This application is a continuation of International Patent Application No. PCT/JP2017/032296 filed on Sep. 7, 2017, the entire disclosures of which is incorporated herein by reference.

### BACKGROUND OF THE INVENTION

### Field of the Invention

The present invention relates to a vehicle, and a control device and a control method of the vehicle.

### Description of the Related Art

Japanese Patent Laid-Open No. 9-161196 describes a control device that controls switching between automated driving and manual driving of a vehicle. The control device detects that the vehicle approaches a scheduled point to switch from automated driving to manual driving, and when the control device determines that switching to the manual driving is not completed before the vehicle reaches the scheduled point, the control device forcefully decelerates the vehicle and stops the vehicle on a roadside strip.

### SUMMARY OF THE INVENTION

Stopping a vehicle on a roadside strip reduces an influence on other vehicles on traffic. However, stopping on the roadside strip is not always the best. One aspect of the present invention provides a technique for determining a favorable position of a vehicle when decelerating or stopping the vehicle.

According to one embodiment, a control device is provided that performs travel control of a vehicle, the control device comprising: a sensor that detects a state of the vehicle and a situation around the vehicle; a travel control unit that performs travel control for automated driving based on detection results of the sensor; and a road surface determination unit that determines whether a road surface on which the vehicle is traveling satisfies a predetermined condition, wherein during execution of stop transition control of decelerating or stopping the vehicle, the travel control unit moves the vehicle to an off-road area adjacent to a traveling road when the road surface determination unit determines that the road surface on which the vehicle is traveling satisfies the predetermined condition, and causes the vehicle to stay on the traveling road when the road surface determination unit determines that the road surface on which the vehicle is traveling does not satisfy the predetermined condition. According to another embodiment, a control device is provided that performs travel control of a vehicle, the control device comprising: a sensor that detects a state of the vehicle and a situation around the vehicle; a travel control unit that performs travel control for automated driving based on a detection result of the sensor; and a road surface determination unit that determines whether a road surface on which the vehicle is traveling is a low μ road, wherein during execution of stop transition control of decelerating or stopping the vehicle, the travel control unit limits an amount of movement of a lateral position of a stop position, or limits a speed of movement when the road surface on which the vehicle is traveling is determined as a low μ road, as compared with a case where the road surface on which the vehicle is traveling is not determined as the low μ road.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings are included in the specification, configure a part of the specification, show embodiments of the present invention, and are used for explaining the principle of the present invention with the description.

FIG. 1 is a block diagram of a vehicle according to an embodiment.

FIG. 2 is a flowchart realizing a process example executed in a control device of the embodiment.

FIG. 3A is a schematic view explaining a stop position of the vehicle of the embodiment.

FIG. 3B is a schematic view explaining a stop position of the vehicle of the embodiment.

### DESCRIPTION OF THE EMBODIMENTS

Embodiments of the present invention will be described with reference to the accompanying drawings. Same elements are assigned with same reference signs throughout various embodiments, and redundant explanation will be omitted. Further, various embodiments can be properly changed and combined.

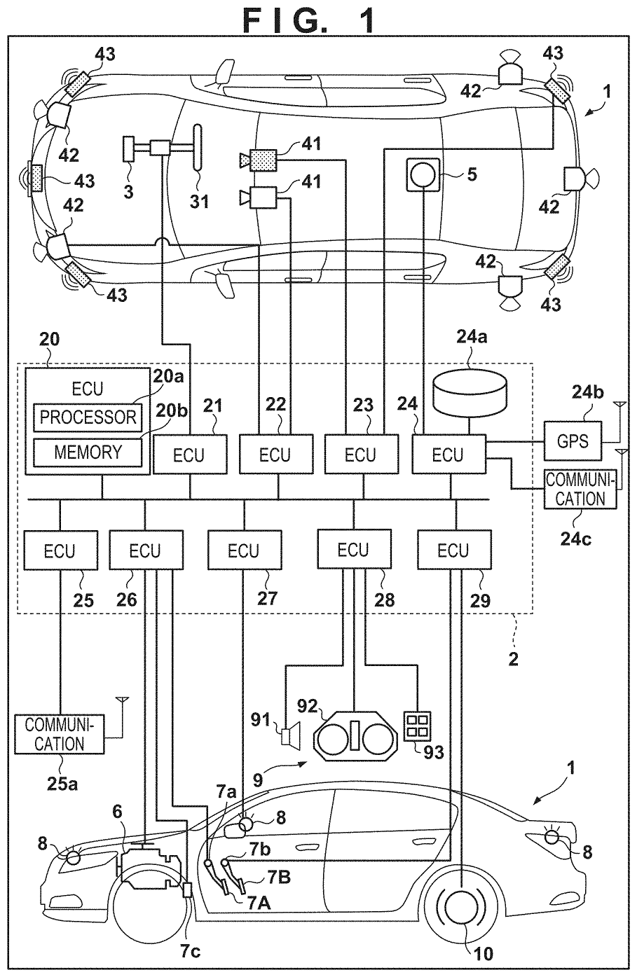

FIG. 1 is a block diagram of a vehicle control device according to one embodiment of the present invention, which controls a vehicle 1. In FIG. 1, an outline of the vehicle 1 is illustrated in a plan view and a side view. The vehicle 1 is a sedan-type four-wheeled passenger car, as an example.

The control device in FIG. 1 includes a control unit 2. The control unit 2 includes a plurality of ECUs 20 to 29 that are communicably connected by an in-vehicle network. Each of the ECUs includes a processor represented by a CPU, a memory such as a semiconductor memory, an interface with an external device, and the like. In the memory, programs executed by the processor, data and the like used in processing by the processor are stored. Each of the ECUs may include a plurality of processors, a plurality of memories, a plurality of interfaces and the like. For example, an ECU 20 includes a processor 20a and a memory 20b. The processor 20a executes a command included by a program stored in the memory 20b, and thereby a process by the ECU 20 is executed. Instead of the processor 20a, the ECU 20 may include an exclusive integrated circuit such as ASIC for executing the process by the ECU 20.

Hereinafter, functions and the like assigned to the respective ECUs 20 to 29 will be described. Note that the number of ECUs, and functions assigned to the ECUs can be properly designed, and can be more fragmented or integrated than the present embodiment.

The ECU 20 executes control relating to automated driving of the vehicle 1. In the automated driving, at least one of steering of the vehicle 1, and/or acceleration and deceleration is automatically controlled. In a control example described later, both of steering, and acceleration and deceleration are automatically controlled.

The ECU 21 controls an electric power steering device 3. The electric power steering device 3 includes a mechanism that steers front wheels in response to a driving operation (steering operation) of a driver to a steering wheel 31. Further, the electric power steering device 3 includes a motor that provides a driving force to assist a steering operation, and automatically steer the front wheels, a sensor that detects a steering angle, and the like. When a driving state of the vehicle 1 is automated driving, the ECU 21 automatically controls the electric power steering device 3 in response to an instruction from the ECU 20, and controls a traveling direction of the vehicle 1.

ECUs 22 and 23 perform control of detection units 41 to 43 that detect a situation around the vehicle, and information processing of detection results. The detection unit 41 is a camera that captures a front of the vehicle 1 (Hereinafter, may be described as a camera 41.), and in the case of the present embodiment, two cameras 41 are provided at a roof front portion of the vehicle 1. By analyzing an image captured by the camera 41, it is possible to extract an outline of a target, and lane division lines (white line and the like) on a road.

A detection unit 42 is a LIDAR (Light Detection and Ranging) (hereinafter, may be described as a LIDAR 42), and detects a target around the vehicle 1 and measures a distance from the target. In the case of the present embodiment, five LIDARs 42 are provided, one at each corner of a front of the vehicle 1, one at a center of a rear, and one on each side of the rear. The detection unit 43 is a millimeter wave radar (hereinafter, may be described as a radar 43), detects a target around the vehicle 1, and measures a distance from the target. In the case of the present embodiment, five radars 43 are provided, one at a center of the front of the vehicle 1, one at each corner of the front, and one at each corner of the rear.

The ECU 22 controls one of the cameras 41 and respective LIDARs 42, and performs information processing of detection results. The ECU 23 controls the other camera 41 and the respective radars 43, and performs information processing of detection results. Two pairs of devices that detect the situation around the vehicle are included, and thereby reliability of the detection result can be increased, and different kinds of detection units such as the cameras, LIDARS and radars are included, and thereby analysis of an environment around the vehicle can be performed from many different angles.

An ECU 24 controls a gyro sensor 5, a GPS sensor 24b and a communication device 24c and performs information processing of detection results or a communication result. The gyro sensor 5 detects a rotational movement of the vehicle 1. A course of the vehicle 1 can be determined by a detection result of the gyro sensor 5, a wheel speed and the like. The GPS sensor 24b detects a current position of the vehicle 1. The communication device 24c wirelessly communicates with a server that provides map information and traffic information, and acquires the map information and traffic information. The ECU 24 is accessible to a database 24a of map information constructed in the memory, and performs a route search from a current location to a destination, and the like. The ECU 24, the map database 24a and the GPS sensor 24b construct a so-called navigation device.

An ECU 25 includes a communication device 25a for vehicle-to-vehicle communication. The communication device 25a performs wireless communication with other surrounding vehicles, and exchanges information among the vehicles.

An ECU 26 controls a power plant 6. The power plant 6 is a mechanism that outputs a drive force to rotate drive wheels of the vehicle 1, and includes an engine and a transmission, for example. The ECU 26 controls an output of the engine in response to a driving operation (an accelerator operation or an acceleration operation) of a driver which is detected by an operation detection sensor 7a provided at an accelerator pedal 7A, and switches a gear ratio of the transmission based on information on a vehicle speed or the like detected by a vehicle speed sensor 7c, for example. When a driving state of the vehicle 1 is automated driving, the ECU 26 automatically controls the power plant 6 in response to an instruction from the ECU 20, and controls acceleration and deceleration of the vehicle 1.

An ECU 27 controls lamps (headlight, tail light and the like) including a direction indicator 8 (blinker). In the case of an example in FIG. 1, the direction indicator 8 is provided at the front, door mirrors and a rear of the vehicle 1.

An ECU 28 controls an input and output device 9. The input and output device 9 outputs information to the driver, and receives input of information from the driver. An audio output device 91 notifies the driver of information by sound. A display device 92 notifies the driver of information by display of an image. The display device 92 is disposed in front of a driver's seat, for example, and configures an instrument panel or the like. Note that sound and display are illustrated here, but information may be notified by vibration and light. Further, information may be notified by combining two or more of sound, display, vibration and light. Furthermore, depending on a level of information to be notified (degree of urgency, for example), different combinations, and different notification modes may be used. The input device 93 is a group of switches disposed at a position operable by the driver and for giving an instruction to the vehicle 1, and may include an audio input device.

The ECU 29 controls a brake device 10 and a parking brake (not illustrated). The brake device 10 is, for example, a disc brake device, is provided at each of the wheels of the vehicle 1, and decelerates or stops the vehicle by adding resistance to rotation of the wheel. The ECU 29 controls an operation of the brake device 10 in response to a driving operation (brake operation) of the driver that is detected by an operation detection sensor 7b provided at a brake pedal 7B, for example. When the driving state of the vehicle 1 is automated driving, the ECU 29 automatically controls the brake device 10 in response to an instruction from the ECU 20, and controls deceleration and stop of the vehicle 1. The brake device 10 and a parking brake can also be operated to keep a stopping state of the vehicle 1. Further, when the transmission of the power plant 6 includes a parking lock mechanism, the parking lock mechanism can also be operated to keep the stopping state of the vehicle 1.

### Control Example

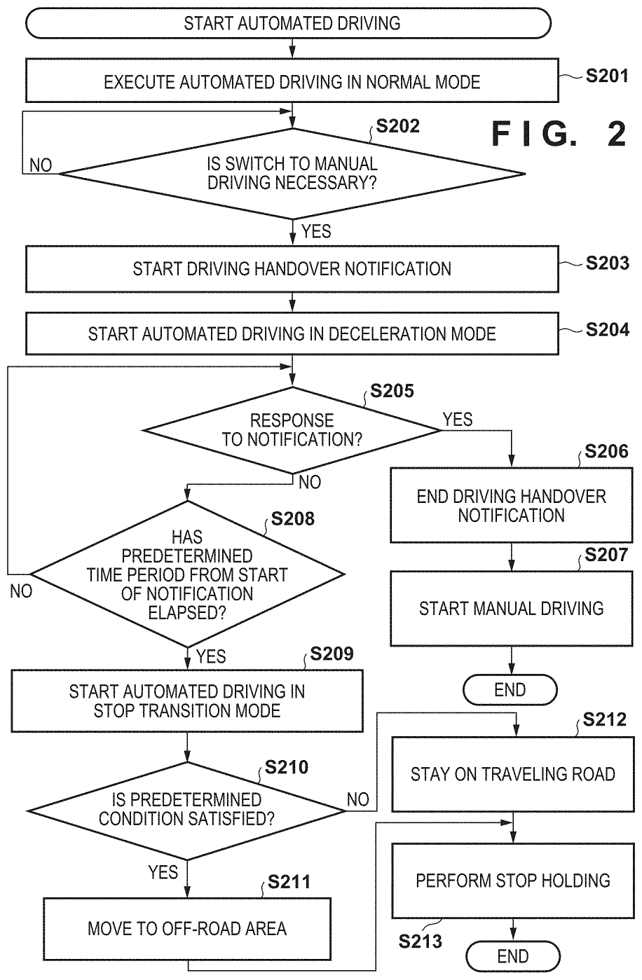

Referring to FIG. 2, a control example of the vehicle 1 by the ECU 20 will be described. A flowchart in FIG. 2 is started when the driver of the vehicle 1 instructs start of automated driving, for example. The ECU 20 functions as a control device of the vehicle 1. Specifically, in the following operation, the ECU 20 functions as a travel control unit that performs travel control for automated driving based on detection results of the sensors (for example, the detection units 41 to 43, the wheel speed sensor, a yaw rate sensor, a G sensor and the like) that detect a state of the vehicle 1 and a situation around the vehicle 1, and a road surface determination unit that determines whether a road surface on which the vehicle is traveling satisfies a predetermined condition. In the present embodiment, the single ECU 20 has functions as the travel control unit and the road surface determination unit, but a separate ECU may be provided for each function.

In step S201, the ECU 20 executes automated driving in a normal mode. The normal mode refers to a mode in which all of steering, driving and braking are executed as necessary to reach the destination.

In step S202, the ECU 20 determines whether switching to manual driving is necessary. The ECU 20 advances the process to step S203 when switching is necessary (“YES” in S202), and repeats step S202 when switching is not necessary (“NO” in step S202). The ECU 20 determines that switching to the manual driving is necessary, when it is determined that some of the functions of the vehicle 1 are reduced, when it is difficult to continue automated driving due to a change in a surrounding traffic state, and when the vehicle 1 reaches a vicinity of the destination set by the driver.

In step S203, the ECU 20 starts driving handover notification. The driving handover notification is notification for requesting the driver to switch to manual driving. Operations in following steps S204, S205, and S208 to S213 are performed during execution of driving handover notification.

In step S204, the ECU 20 starts automated driving in a deceleration mode. The deceleration mode is a mode in which steering and braking are executed as necessary to wait for response to driving handover notification of the driver. In the deceleration mode, the vehicle 1 may be naturally decelerated by engine brake or regenerative brake, or braking using a braking actuator (friction brake, for example) may be performed. Further, the ECU 20 may enhance strength of deceleration regeneration (by increasing a regeneration amount, for example), or may enhance strength of the engine brake (by reducing a gear ratio, for example), even when naturally decelerating the vehicle 1.

In step S205, the ECU 20 determines whether the driver responds to the driving handover notification. The ECU 20 advances the process to step S206 when the driver responds (“YES” in S205), or advances the process to step S208 when the driver does not respond (“NO” in step S205). The driver can use the input device 93, for example, to indicate intention to shift to manual driving. Instead of the input device 93, the driver may indicate intention of consent using steering detected by a steering torque sensor.

In step S206, the ECU 20 ends driving handover notification. In step S207, the ECU 20 ends automated driving in the deceleration mode under execution and starts manual driving. In the manual driving, the respective ECUs of the vehicle 1 control travel of the vehicle 1 according to the driving operation of the driver. The ECU 28 may output a message or the like that prompts the driver to bring the vehicle 1 to a garage to the display device 92, because the ECU 20 may have performance degradation or the like.

In step S208, the ECU 20 determines whether a predetermined time period (for example, a time period corresponding to an automated driving level of the vehicle 1 such as four seconds, 15 seconds or the like) elapses after start of driving handover notification. The ECU 20 advances the process to step S209 when the predetermined time period elapses (“YES” in S208), or returns the process to step S205 to repeat the processes of step S205 and the following steps, when the predetermined time period does not elapse (“NO” in step S208).

In step S209, the ECU 20 ends automated driving in a deceleration mode under execution and starts automated driving in a stop transition mode. The stop transition mode is a mode for stopping the vehicle 1 in a safe position or decelerating the vehicle 1 to a lower speed than a deceleration end speed in the deceleration mode. Specifically, the ECU 20 searches for a position where the vehicle 1 is stoppable while actively decelerating the vehicle 1 to the speed lower than the deceleration end speed in the deceleration mode. When the ECU 20 can find the stoppable position, the ECU 20 stops the vehicle 1 in the stoppable position, or when the ECU 20 cannot find the stoppable position, the ECU 20 searches for a stoppable position while causing the vehicle 1 to travel at an extremely low speed (a creep speed, for example). Operations in following steps S210 to S213 are performed during execution of the stop transition mode.

In step S210, the ECU 20 determines whether a road surface on which the vehicle 1 is traveling satisfies a predetermined condition. The ECU 20 advances the process to step S211 when the road surface satisfied the predetermined condition (“YES” in S210), or advances the process to step S212 when the road surface does not satisfy the predetermined condition (“NO” in step S210).

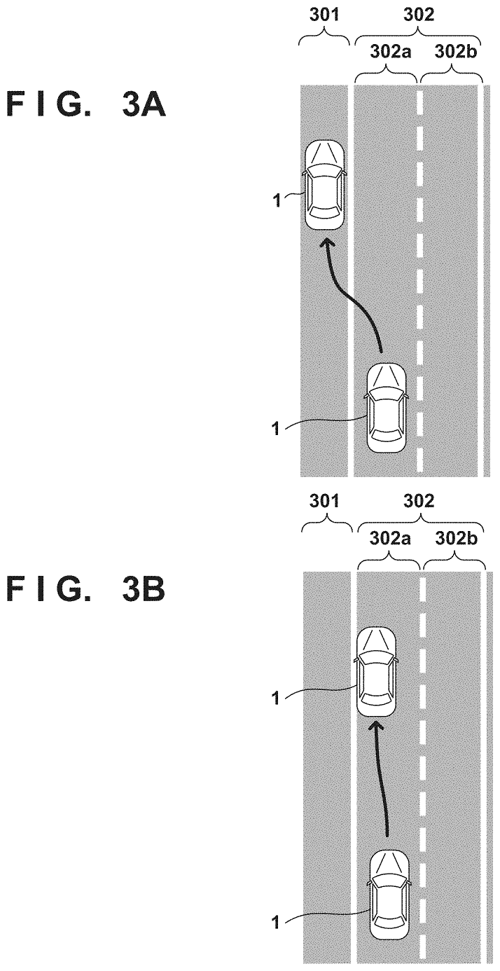

Referring to FIGS. 3A and 3B, the predetermined condition in step S210 will be described. In explanation in FIGS. 3A and 3B, the vehicle 1 is assumed to be traveling on a left-hand road. The road on which the vehicle 1 is traveling is configured by a traveling road 302 and an off-road area 301 (a roadside strip or a road shoulder, for example) adjacent to the traveling road 302. In examples in FIGS. 3A and 3B, the traveling road 302 is divided into two lanes 302a and 302b.

In step S211, the ECU 20 moves the vehicle 1 to the off-road area 301 in a period before stopping the vehicle 1, as illustrated in FIG. 3A. In step S212, the ECU 20 keeps the vehicle 1 on the traveling road 302 until the ECU 20 stops the vehicle 1, as illustrated in FIG. 3B. The ECU 20 may change the lane in the traveling road 302 as necessary.

As illustrated in FIG. 3A, when stopping the vehicle 1, moving the vehicle 1 to the off-road area 301 can suppress interference with traffic of other vehicles. However, when the road surface does not satisfy the predetermined condition, for example, when the road surface is a low μ road (road surface with a low friction coefficient), it may be difficult to move the vehicle 1 to the off-road area 301, and start the vehicle 1 from the off-road area 301. As a specific example in the case of the road surface being a low μ road, a case where the road surface is frozen or is covered with snow is cited.

The ECU 20 may determine whether the road surface satisfies the predetermined condition based on at least one of a detection result of internal sensor of the vehicle 1, a detection result of external sensors of the vehicle 1, and/or communication contents that the vehicle 1 communicates with the outside. Specifically, when the state of the road surface is determined based on the detection result of the internal sensors of the vehicle 1, the ECU 20 may determine the state of the road surface based on a yaw rate and a lateral acceleration, a wheel speed, a throttle opening degree, and a brake pedal force. For example, the ECU 20 may determine that the road surface is a low μ road when a ratio of the vehicle speed to the wheel speed is low, as compared with the case of the normal road surface. Further, when wheel slip and skid are detected, the ECU 20 can estimate a friction coefficient of the road surface besides the throttle opening degree with which the slip occurs, and the brake pedal force with which the skid occurs. Further, the ECU 20 detects, for example, the yaw rate and the acceleration in the lateral direction with the sensors, compares the yaw rate obtained from the speed and the steering angle of the vehicle 1 and the acceleration in a lateral direction, and can detect a sideslip of the vehicle based on a degree of match of the yaw rate and the acceleration in the lateral direction. The ECU 20 can also estimate a degree of the friction coefficient of the road surface from the speed and the steering angle with which the sideslip occurs, for example. The ECU 20 can determine that the current road surface is a low μ road when the friction coefficient of the road surface that is estimated is smaller than a predetermined threshold value.

When the state of the road surface is determined based on the detection result of the external sensors of the vehicle 1, the ECU 20 may use, for example, an outside air temperature acquired by an outside air temperature sensor, visibility determined from a distance to a target obtained by the LIDAR 42 and the like. When the captured image by the camera 41 is recognized and the entire road surface is white, the ECU 20 can determine that the road surface is covered with snow. When a temperature below freezing (or a temperature below freezing and equal to or less than a predetermined temperature) is detected as a current outside air temperature by the outside air temperature sensor, the ECU 20 may determine that the road surface is frozen. Further, when the ECU 20 determines swirling of snow by the sensors such as the LIDARs 42 and the radars 43, the ECU 20 can determine that the road surface is covered with snow.

When the vehicle 1 determines the state of the road surface based on the communication contents that the vehicle 1 communicates with the outside, the ECU 20 may use, for example, information obtained from VICS (road traffic information communication system), information received from other vehicles, weather information and the like. For example, the information from VICS may include information on the area where the road surface is frozen or covered with snow.

When the vehicle 1 is caused to stay on the traveling road 302 until the vehicle 1 is stopped, the ECU 20 may stop the vehicle 1 in a position deviating from a center of the lane of the traveling road 302, as illustrated in FIG. 3B. A state where the vehicle 1 stops in the position that deviates from the center of the lane is a state where the center of the lane is not superimposed on a center line of the vehicle 1, for example. The center of the lane indicates a portion on which the center line of the vehicle is superimposed during normal traveling, for example. Further, when the vehicle 1 is caused to stay on the traveling road 302 until the vehicle 1 is stopped, the ECU 20 may stop the vehicle 1 in a position avoiding wheel marks (wheel tracks, for example) on the traveling road 302. The wheel marks may be portions where amounts of covering snow are small on the road surface covered with snow.

In step S213, the ECU 20 determines stop of the vehicle 1 from a detection result of an engine speed sensor, and when the ECU 20 determines that the vehicle 1 stops, the ECU 20 instructs the ECU 29 to actuate an electric parking lock device and performs stop holding control to keep stoppage of the vehicle 1. When automated driving in the stop transition mode is performed, it may be notified to other surrounding vehicles that the stop transition is performed, by a hazard lamp, or other display devices, or it may be notified to the other vehicles and other terminal devices, by the communication device. During execution of the automated driving in the stop transition mode, the ECU 20 may perform deceleration control depending on presence or absence of a following vehicle. For example, the ECU 20 may increase a degree of deceleration when there is no following vehicle more than the degree of deceleration in the case of the following vehicle being present.

When it is determined whether the road surface on which the vehicle traveling is a low μ road or not as determination of whether the predetermined condition is satisfied, in the aforementioned control method, an amount of movement of a lateral position of a stop position may be limited or a speed of movement may be limited in S212 (when the traveling road surface is determined as a low μ road), as compared with S211 (when it is determined that the traveling road surface is not a low μ road). As a result that a moving amount of the lateral position of the stopping position is limited, the vehicle 1 may stay on the traveling road 302 as described above. When the speed of movement is limited, the lateral position of the stop position of the vehicle 1 may be the same regardless of whether or not the road surface on which the vehicle is traveling is a low μ road. In other words, with respect to the same lateral position, the vehicle 1 takes longer time to move when the road surface on which the vehicle is traveling is a low μ road as compared with the case where the road surface on which the vehicle is traveling is not a low μ road. These limitations can reduce a risk at a time of stopping.

In the above described embodiment, as the automated driving control executed by the ECU 20 in the automated driving mode, the automated driving control to automate all of driving, braking and steering is described, but automated driving control can control at least one of driving, braking and/or steering without depending on the driving operation of the driver. To control without depending on the driving operation of the driver includes to control without input by the driver to the controllers represented by a steering wheel, and a pedal, or can be said that the intention of the driver to drive the vehicle is not essential. Accordingly, automated driving control may be in a state in which the driver is obliged to monitor the surroundings, and at least one of driving, braking and/or steering of the vehicle 1 is controlled according to surrounding environment information of the vehicle 1, or in a state in which the driver is obliged to monitor the surroundings, and at least one of driving and/or braking of the vehicle 1, and steering are controlled according to the surrounding environment information of the vehicle 1, or in a state in which the driver is not obliged to monitor the surroundings, and all of driving, braking and steering of the vehicle 1 are controlled according to the surrounding environment information of the vehicle 1. Further, the automated driving control may be capable of transitioning to these respective control stages. Further, sensors that detect state information of the driver (biological information such as a heart rate, state information on facial expression and pupils) are provided, and automated driving control may be executed or suppressed according to detection results of the sensors.

### Summary of Embodiment

### <Configuration 1>

A control device that performs travel control of a vehicle (1), the control device comprising:

a sensor (41 to 43) that detects a state of the vehicle and a situation around the vehicle;

a travel control unit (20) that performs travel control for automated driving based on detection results of the sensor; and

a road surface determination unit (20) that determines whether a road surface on which the vehicle is traveling satisfies a predetermined condition, wherein

during execution of stop transition control of decelerating or stopping the vehicle, the travel control unit

moves the vehicle to an off-road area (301) adjacent to a traveling road when the road surface determination unit determines that the road surface on which the vehicle is traveling satisfies the predetermined condition, and

causes the vehicle to stay on the traveling road (302) when the road surface determination unit determines that the road surface on which the vehicle is traveling does not satisfy the predetermined condition.

According to the configuration, a favorable vehicle position when decelerating or stopping the vehicle can be determined. More specifically, restart of the vehicle is facilitated by causing the vehicle to stay on the traveling road when the road surface does not satisfy the predetermined condition.

### <Configuration 2>

The control device according to configuration 1, wherein the predetermined condition includes that the road surface is not a low μ road.

According to the configuration, a favorable vehicle position can be determined when the road surface is not a low μ road.

### <Configuration 3>

The control device according to configuration 1 or 2, wherein the road surface determination unit

determines whether the road surface on which the vehicle is traveling satisfies the predetermined condition based on at least one of
a detection result of an internal sensor of the vehicle,
a detection result of an external sensor of the vehicle, and/or
a communication content that the vehicle communicates with an outside.

According to the configuration, it becomes possible to properly detect the state of the road surface.

### <Configuration 4>

The control device according to any one of configurations 1 to 3, wherein the travel control unit stops the vehicle in a position deviating from a center of a lane of a traveling road, when stopping the vehicle on the traveling road in the stop transition control.

According to the configuration, it becomes possible to reduce interference with traffic of following vehicles.

### <Configuration 5>

The control device according to any one of configurations 1 to 4, wherein the travel control unit stops the vehicle in a position avoiding wheel marks on a traveling road when stopping the vehicle on the traveling road in the stop transition control.

According to the configuration, it becomes possible to reduce interference with traffic of following vehicles by avoiding wheel marks that would allow the following vehicles to pass.

### <Configuration 6>

The control device according to any one of configurations 1 to 5, wherein the travel control unit performs stop holding control after stopping the vehicle.

According to the configuration, it becomes possible to reduce a burden on the actuator and the like.

### <Configuration 7>

The control device according to any one of configurations 1 to 6, wherein the travel control unit performs deceleration control depending on presence or absence of a following vehicle in the stop transition control.

According to the configuration, it becomes possible to perform appropriate deceleration while considering the following vehicle.

### <Configuration 8>

The control device according to any one of configurations 1 to 7, wherein the travel control unit starts the stop transition control after performing driving handover notification to a driver of the vehicle.

According to the configuration, it becomes possible to start stop transition control after confirming presence or absence of a response of the driver.

### <Configuration 9>

A control device that performs travel control of a vehicle (1), the control device comprising:

a sensor (41 to 43) that detects a state of the vehicle and a situation around the vehicle;

a travel control unit (20) that performs travel control for automated driving based on a detection result of the sensor; and

a road surface determination unit (20) that determines whether a road surface on which the vehicle is traveling is a low μ road, wherein

during execution of stop transition control of decelerating or stopping the vehicle, the travel control unit
limits an amount of movement of a lateral position of a stop position, or limits a speed of movement when the road surface on which the vehicle is traveling is determined as a low μ road, as compared with a case where the road surface on which the vehicle is traveling is not determined as the low μ road.

According to the configuration, it is possible to determine a favorable vehicle position when decelerating or stopping the vehicle. Specifically, a risk at a time of moving can be reduced by limiting the amount of movement of the lateral position of the stop position or limiting the speed of movement when the road surface is a low μ road.

### <Configuration 10>

A vehicle, comprising

the control device according to any one of configurations 1 to 9, and

an actuator group controlled by the travel control unit of the control device.

According to the configuration, it is possible to provide the vehicle that decelerates or stops in a favorable position.

### <Configuration 11>

A control method of a vehicle (1) including a sensor (41 to 43) that detects a state of the vehicle and a situation around the vehicle, and performing travel control for automated driving based on detection results of the sensor, the method comprising:

determining whether a road surface on which the vehicle is traveling satisfies a predetermined condition; and

during execution of stop transition control of decelerating or stopping the vehicle,
moving the vehicle to an off-road area (301) adjacent to a traveling road when it is determined that the road surface on which the vehicle is traveling satisfies the predetermined condition, and
causing the vehicle to stay on the traveling road (302) when it is determined that the road surface on which the vehicle is traveling does not satisfy the predetermined condition.

According to the configuration, it is possible to determine a favorable vehicle position when decelerating or stopping the vehicle. Specifically, restart of the vehicle is facilitated by causing the vehicle to stay on the traveling road when the road surface does not satisfy the predetermined condition.

### <Configuration 12>

A control method of a vehicle (1) including a sensor (41 to 43) that detects a state of the vehicle and a situation around the vehicle, and performing travel control for automated driving based on detection results of the sensor, the method comprising:

determining whether a road surface on which the vehicle is traveling is a low μ road; and

during stop transition control of decelerating or stopping the vehicle,
limiting an amount of movement of a lateral position of a stop position or limiting a speed of movement when the road surface on which the vehicle is traveling is determined as a low μ road, as compared with a case where the road surface on which the vehicle is traveling is not determined as the low μ road.

According to the configuration, it is possible to determine a favorable vehicle position when decelerating or stopping the vehicle. Specifically, a risk at a time of moving can be reduced by limiting the amount of movement of the lateral position of the stop position or limiting the speed of movement when the road surface is a low μ road.

The present invention is not limited to the above embodiments and various changes and modifications can be made within the spirit and scope of the present invention. Therefore, to apprise the public of the scope of the present invention, the following claims are made.

What is claimed is:

1. A control device that performs travel control of a vehicle, the control device comprising:
a sensor that detects a state of the vehicle and a situation around the vehicle;
a travel control unit that performs travel control for automated driving based on detection results of the sensor; and
a road surface determination unit that determines whether a road surface on which the vehicle is traveling satisfies a predetermined condition, wherein
during execution of stop transition control of decelerating or stopping the vehicle, the travel control unit
moves the vehicle to an off-road area adjacent to a traveling road, when the road surface determination unit determines that the road surface on which the vehicle is traveling satisfies the predetermined condition, and
causes the vehicle to stay on the traveling road when the road surface determination unit determines that the road surface on which the vehicle is traveling does not satisfy the predetermined condition.

2. The control device according to claim 1, wherein the predetermined condition includes that the road surface is not a low μ road.

3. The control device according to claim 1, wherein
the road surface determination unit determines whether the road surface on which the vehicle is traveling satisfies the predetermined condition based on at least one of
a detection result of an internal sensor of the vehicle,
a detection result of an external sensor of the vehicle, and/or
a communication content that the vehicle communicates with an outside.

4. The control device according to claim 1, wherein the travel control unit stops the vehicle in a position deviating from a center of a lane of a traveling road, when stopping the vehicle on the traveling road in the stop transition control.

5. The control device according to claim 1, wherein the travel control unit stops the vehicle in a position avoiding wheel marks on a traveling road when stopping the vehicle on the traveling road in the stop transition control.

6. The control device according to claim 1, wherein the travel control unit performs stop holding control after stopping the vehicle.

7. The control device according to claim 1, wherein the travel control unit performs deceleration control depending on presence or absence of a following vehicle in the stop transition control.

8. The control device according to claim 1, wherein the travel control unit starts the stop transition control after performing driving handover notification to a driver of the vehicle.

9. A control device that performs travel control of a vehicle, the control device comprising:
a sensor that detects a state of the vehicle and a situation around the vehicle;
a travel control unit that performs travel control for automated driving based on a detection result of the sensor; and
a road surface determination unit that determines whether a road surface on which the vehicle is traveling is a low μ road, wherein
during execution of stop transition control of decelerating or stopping the vehicle, the travel control unit
limits an amount of movement of a lateral position of a stop position, or limits a speed of movement when the road surface on which the vehicle is traveling is determined as a low μ road, as compared with a case where the road surface on which the vehicle is traveling is not determined as the low μ road.

10. A vehicle, comprising:
the control device according to claim 1, and
an actuator group controlled by the travel control unit of the control device.

11. A vehicle, comprising:
the control device according to claim 9, and
an actuator group controlled by the travel control unit of the control device.

12. A control method of a vehicle including a sensor that detects a state of the vehicle and a situation around the vehicle, and performing travel control for automated driving based on detection results of the sensor, the method comprising:
determining whether a road surface on which the vehicle is traveling satisfies a predetermined condition; and
during execution of stop transition control of decelerating or stopping the vehicle,
moving the vehicle to an off-road area adjacent to a traveling road, when it is determined that the road surface on which the vehicle is traveling satisfies the predetermined condition, and
causing the vehicle to stay on the traveling road when it is determined that the road surface on which the vehicle is traveling does not satisfy the predetermined condition.

13. A control method of a vehicle including a sensor that detects a state of the vehicle and a situation around the vehicle, and performing travel control for automated driving based on detection results of the sensor, the method comprising:
determining whether a road surface on which the vehicle is traveling is a low μ road; and
during stop transition control of decelerating or stopping the vehicle,
limiting an amount of movement of a lateral position of a stop position or limiting a speed of movement when the road surface on which the vehicle is traveling is determined as a low μ road, as compared with a case where the road surface on which the vehicle is traveling is not determined as the low μ road.
